(19) United States
(12) Patent Application Publication
(10) Pub. No.: US 2016/0203591 A1
(43) Pub. Date: Jul. 14, 2016

(54) SYSTEM AND PROCESS FOR MONITORING THE QUALITY OF FOOD IN A REFRIGERATOR

(71) Applicant: Umm Al-Qura University, Makkah (SA)

(72) Inventors: Eman Khalid Justaniah, Makkah (SA); Ibtehaj Mohammad Audah Al-zhrani, Makkah (SA); Elaf Jameel Siraj Islam, Makkah (SA); Nafisah Matouk Mohammad Khashaifaty, Makkah (SA)

(21) Appl. No.: 14/593,837

(22) Filed: Jan. 9, 2015

(51) Int. Cl. G06T 7/00; F25D 11/00

(52) U.S. Cl. CPC G06T 7/0004; F25D 11/00; G06T 2207/30128

(57) ABSTRACT

A system and process for automatically monitoring and assessing the quality of food items stored in a refrigerator scans and captures images of the food with at least one camera or 3D scanner mounted in the refrigerator. A processor connected with the camera or scanner uses software including a MATLAB package, a Structured Query Language (SQL) database, and a Database Toolbox that lets the user store data in and access databases from MATLAB with SQL support, enabling the user to analyze, explore, and manipulate the data. A user interface touchscreen on the refrigerator displays the results of a scan and lets the user request a scan or a report at other than a normally scheduled time. The touchscreen also displays the location of food items in the refrigerator.

### FIELD OF THE INVENTION

This invention relates generally to smart refrigerators, and more particularly to a smart refrigerator that has a system based on image processing and analysis methods using MATLAB language to monitor the condition of food items in the refrigerator and alert the user when a food item is spoiled or on the verge of being spoiled.

### BACKGROUND ART

To keep many foods from spoiling they must be refrigerated, but even refrigerated foods will remain edible only for a limited period of time. To ensure that foods are consumed before they spoil, it previously has been necessary to manually inspect the food. This typically requires checking on a daily basis and involves considerable time and effort.

Refrigerators have been developed in the prior art that use a camera to read labels on items stored in the refrigerator and compare the labels with expiration dates, or to keep track of items in the refrigerator and inform the user when items need to be restocked. See, for example, U.S. Pat. Nos. 6,741,236 and 6,919,795, published US patent application 2013/058991, and published international application WO 2013/058991. Published international patent application WO 2013/096243 analyzes specific excitation wavelengths given off by food to detect spoilage.

Samsung has produced an intelligent refrigerator that contains a touch screen and a camera that scans the contents of the refrigerator and decides which contents need to be restocked.

In 2012 LG developed a Smart Manager Fridge that orders food online, offers up recipe ideas, and switches on the oven for the user [6].

Another smart refrigerator is Siemens' Camera Fridge, introduced in 2013. That refrigerator allows the user to control the temperature via iPad if Siemens' Connectivity app is installed. It also can take a picture of the fridge's contents and send the picture to the user's iPad or smart phone so the user can easily determine from a remote location, such as a supermarket, if any of the food items need to be restocked [7].

Hitachi has also developed an intelligent refrigerator that keeps foods fresh for a longer period of time by use of an intelligent cooling system and a humidity-controlled vegetables compartment [5].

Prior systems that use a camera or cameras to read labels on food items to determine expiration dates require appropriate positioning of the food items relative to the camera, but even if the item is appropriately positioned other food items may block the view of the camera so that the label cannot be read.

Other systems have been proposed for testing the ripeness and quality of fruit on farms. In April, 2011, a study was conducted at Jiangsu University in China relating to the design of harvesting robots using a CCD camera to harvest fruit according to its growth conditions. The conditions were divided into five different phases: breakers, turning, pink, light-red, and red phase. Those phases were determined by analyzing the HIS and RGB color modes of images taken of tomatoes. According to the value of the colors red and green, the system can determine the stage of ripeness of the fruit [14].

A study to determine the quality of fruit was published in the CIGR Journal, Vol. 15, No. 1, March, 2013, reporting research conducted by two researchers at the department of Micro-Nano System Engineering, Nagoya University, Nagoya, Japan. The research involved sorting tomatoes with a low cost machine vision system that took images of the tomatoes and analyzed the colors in the image in three models: RGB, HSV and Binary. In addition to checking whether a tomato was good or bad, this research also categorized the kind of defects, if any, i.e. it sorted defects due to mold, blossom end rot (BER) or breakdown, and damage done by pests and insects [15].

The two studies mentioned above that were conducted in China and Japan are designed for determining the suitability of produce for harvesting and/or sale.

Applicant is not aware of any prior system that monitors the freshness of food items stored in a refrigerator by using cameras to take images of the items and then analyzes those images to determine whether the food is spoiled or about to become spoiled and that also informs the user of the location of the food items.

In particular, applicant is not aware of any prior system that takes images of fruit stored in a refrigerator, analyzes the color, and compares it with benchmark colors to determine the state of freshness of the fruit.

It would be desirable to have a camera-based system in a refrigerator that takes images of food items stored in the refrigerator, analyzes those images to determine the state of freshness of the items, and displays the results to the user.

### SUMMARY OF THE INVENTION

The present invention is a camera-based apparatus and process that automatically monitors and assesses the quality of food stored in a refrigerator by taking images of the food items, analyzing those images to determine the state of freshness of the items, and displaying the results to the user. The system also alerts the user if defective fruit is detected.

More specifically, the system of the invention checks food items in a refrigerator on a daily basis and allows the user to see which food is in good condition or is on the verge of being spoiled or that is already spoiled and unfit for use. The system is based on image processing and analysis methods using MATLAB language. In a first phase the system filters the image and removes noise such as dust traces on the food item. In a second phase the system removes the background part of the image in order to identify and analyze the color of the food item. The color is then compared with benchmark colors for that item. Finally, the quality of the food item is determined based on a color-matching algorithm.

The system allows the user to request examination of the quality of food items at any time and view a report prepared by the system and displayed on a user interface touchscreen. A summary report of the last seven days is also saved for display.

In a preferred embodiment the images of the food items are taken by at least one 3-D scanner. The images are then analyzed by the system to detect defects and to determine the state of freshness. The system also informs the user of the location in the refrigerator of food items that are defective, and food items near the defective item and likely to be affected by it.

The system of the invention as disclosed herein is designed for assessing the quality of fruit, but it should be understood that the system could be adapted to assessing the quality of other food items.

In the preferred embodiment, the system monitors the quality of fruit in the refrigerator every day, and allows the user to request scanning any time desired. The user can also see a report of the last fruit quality test, and can see a summary of weekly scanning results. The preferred system also has a shelf or shelves divided into areas so that good fruit can be kept isolated from defective fruit and wetness can be reduced.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a front view in elevation of the exterior of a refrigerator equipped with the system of the invention.

FIG. 2 is a front view in elevation of the interior of a refrigerator equipped with the system of the invention.

FIG. 3 is a user interface main screen.

FIG. 4 is a screen that appears temporarily while scanning is taking place.

FIG. 5 is a screen that appears when the scanning process is complete and it contains a single button that can be pressed to view the report.

FIG. 6 is a screen showing a report of the scan results, showing the number of defective food items defected and the number of food items near the defective item or items.

FIG. 7 is a user interface screen that appears if the “show location” button is pushed in the previous screen, and shows the locations of defective food items and items nearby that may be affected.

FIG. 8 is a screen showing a report of weekly scan results.

FIG. 9 is a diagram representing the overall context of the invention.

FIG. 10 is a diagram representing the data flow in the system of the invention at a level 0.

FIG. 11 is a diagram representing the data flow in the system of the invention at a level 1.

FIG. 12 is an entity relationship diagram.

FIG. 13 is a flow chart diagram of the system.

FIG. 14 is a system structure chart diagram.

FIG. 15 is an algorithm of the system operation.

### DETAILED DESCRIPTION OF THE PREFERRED EMBODIMENTS

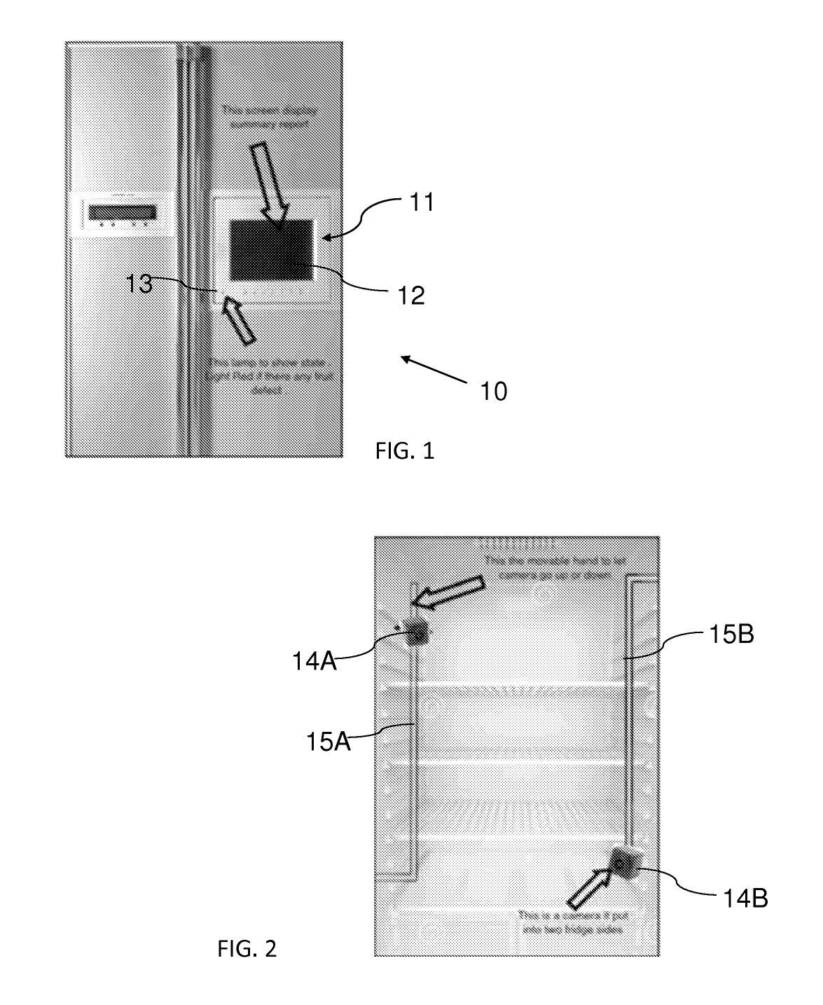

A refrigerator having the system of the invention is indicated generally at 10 in FIGS. 1 and 2. A display and control panel 11 is on the outside of the refrigerator door. The panel includes a user interface touchscreen 12 and a light 13 that illuminates if a defective food item is detected by the system.

As shown in FIG. 2, at least one and preferably two cameras or 3-D scanners 14A and 14B are mounted on respective rails 15A and 15B extending vertically at opposite sides of the refrigerator. The cameras move along the rails so that images can be taken at various levels in the refrigerator.

The cameras are connected with a processor, not shown, that contains software to capture the image taken by the cameras or scanners, analyze the image, determine the quality of the food, and produce a report. The software includes a Windows operating system, a MATLAB package, a Structured Query Language (SQL) database, and a Database Toolbox that lets the user store data in and access databases from MATLAB with SQL support, enabling the user to analyze, explore, and manipulate the data. In the particular example disclosed herein, the system is designed to monitor and assess the quality of fruit stored in the refrigerator, although it can be adapted to monitor and analyze other foods.

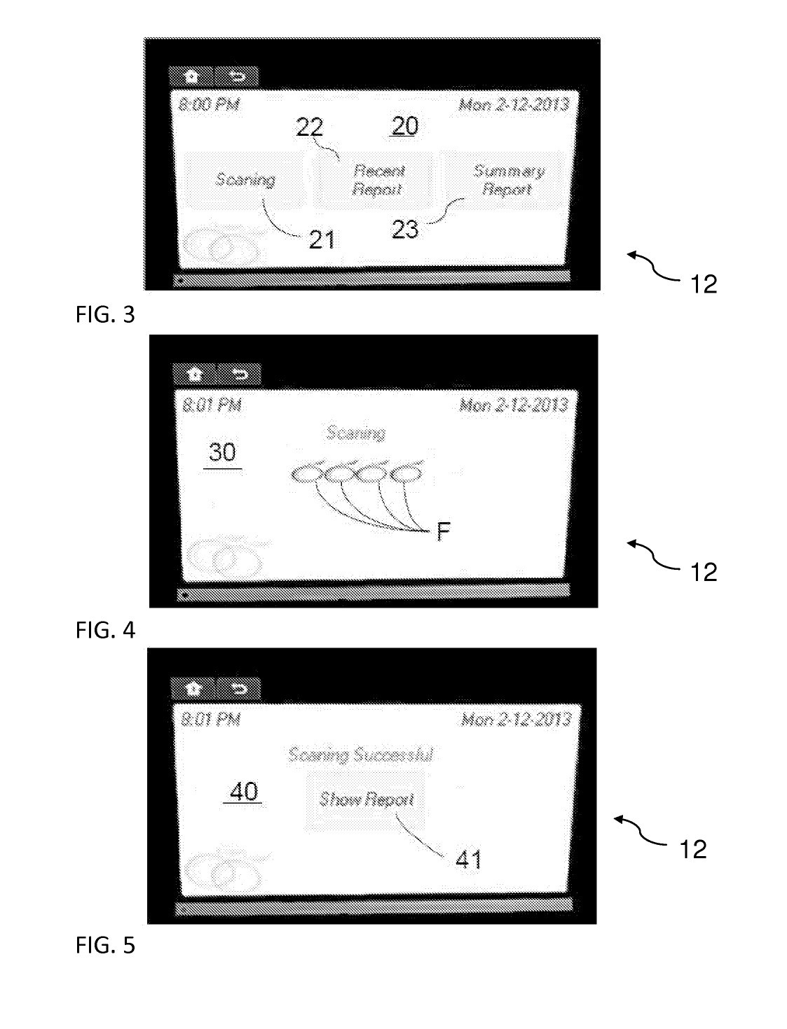

The main screen 20 for the user interface touchscreen 12 is shown in FIG. 3. As indicated, there are three buttons: (1) button 21 to initiate a scan; (2) button 22 to request a recent report; and (3) button 23 to request a summary report.

FIG. 4 shows the screen display 30 during scanning, and depicts several fruit icons F.

FIG. 5 depicts the screen display 40 when a scan is completed, and has a single button 41 that the user can press to obtain a report of the results of the scan.

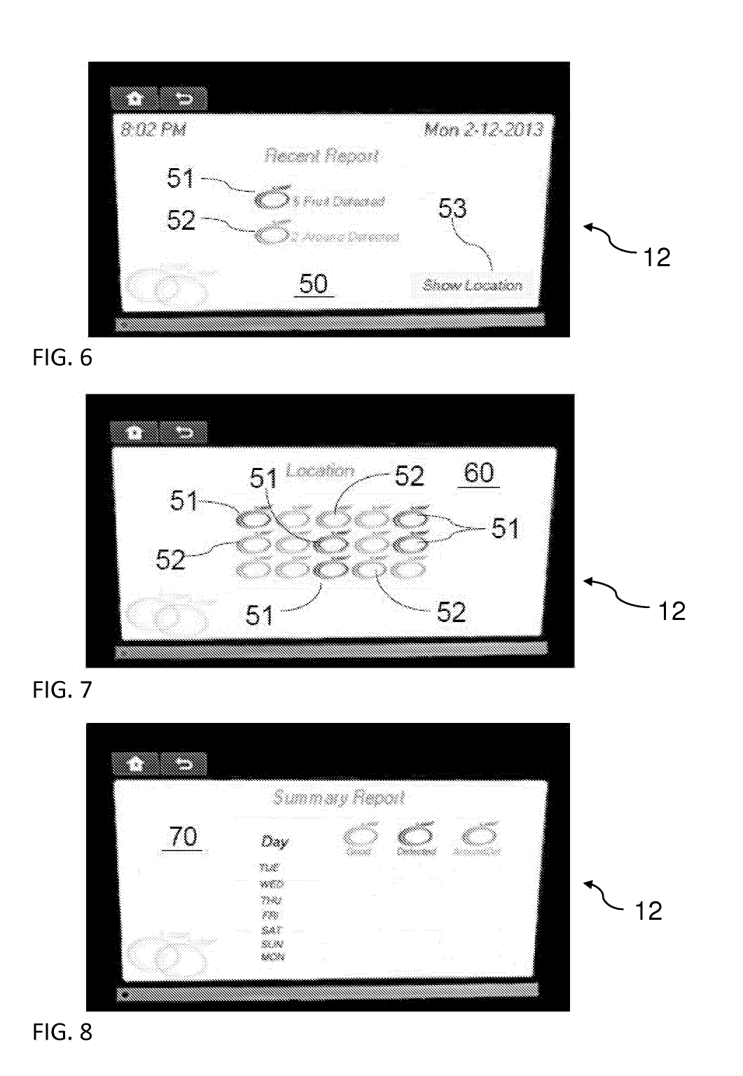

FIG. 6 shows the screen 50 displaying the recent scan results. This screen displays an icon 51 in the color red to indicate a defective fruit, with a text message next to the icon giving the number of items of defective found by the system. An icon 52 in the color orange is also displayed to indicate pieces of fruit closely adjacent to a defective piece and that might be affected by the defective piece. A text message next to the icon 52 gives the number of such pieces of fruit detected by the system. A button 53 on this screen may be pressed by the user to obtain a display showing the location of the pieces of fruit 51 and 52 reported in the previous screen.

Screen 60, shown in FIG. 7, displays the locations of defective pieces of fruit 51 and pieces 52 that might be affected by being close to a defective piece. Pieces of fruit that are still good are represented by the green icons.

Screen 70, shown in FIG. 8, displays a summary report for the preceding week.

The system is available at all times if the user wants to check the quality of fruit stored in the refrigerator. Further, since the system automatically scans the contents of the refrigerator at least once a day, if defective fruit is found the system will illuminate a red light on the user interface screen to alert the user.

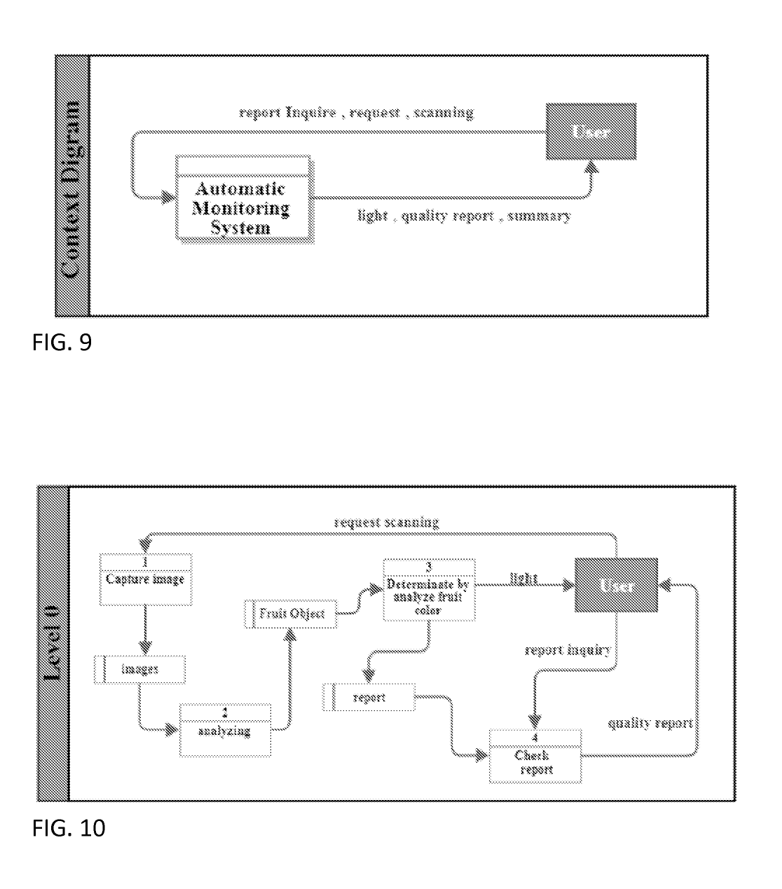

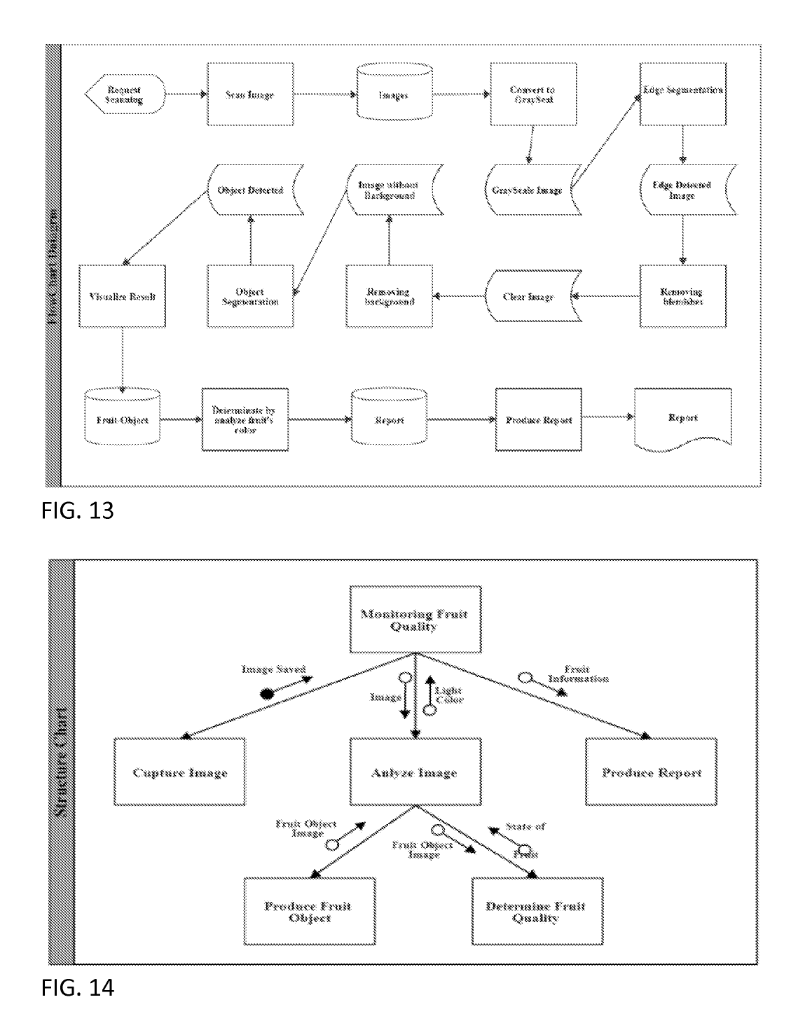

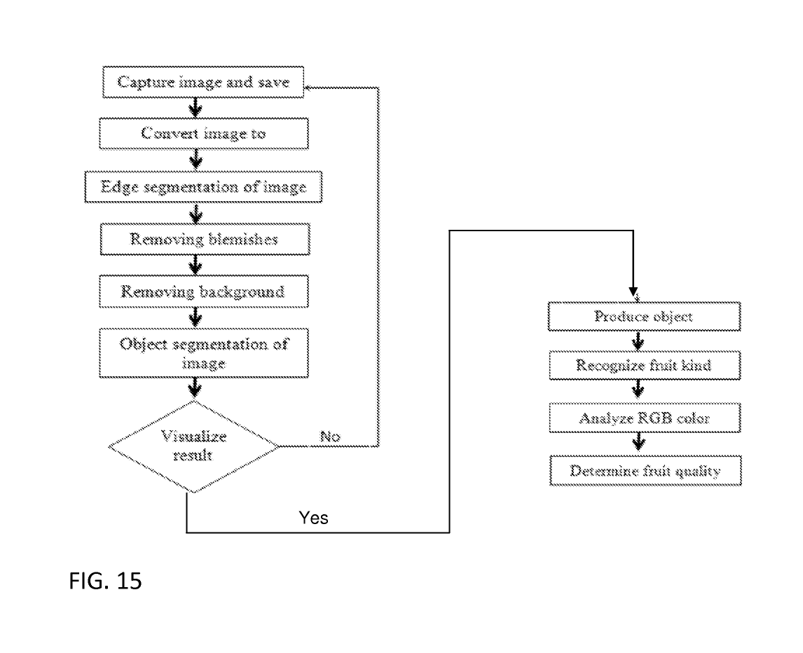

In operation, as depicted in FIGS. 9-15, the user can input a request on screen 12 for a scan or a report. If the system is conducting a scan, the cameras capture an image of the defined fruit, analyze the image based on the color, and generate a report. The report can be automatically displayed to the user, or the user can request a report.

Images taken by the cameras or scanners are saved temporarily to a file for processing, and the software then analyzes the images to assess the quality of the fruit, as explained more fully hereinafter.

To use the system for monitoring the freshness of fruit in the refrigerator, that fruit must be defined in the system. That is, benchmark colors for that fruit must be defined in the system. When the cameras capture an image of the fruit and the colors in the captured image are compared with the benchmark, the system can assess the condition of the fruit. The system is based on image processing and analysis methods using MATLAB language. If a defined fruit is not present in the refrigerator the system will stop processing.

In a first phase the image is filtered to remove noise such as dust traces on the image of fruit. In a second phase the background part of the image is removed in order to identify and analyze the fruit color. The color is then compared with the benchmark fruit colors. Finally, the quality of the fruit is determined based on its color matching algorithm.

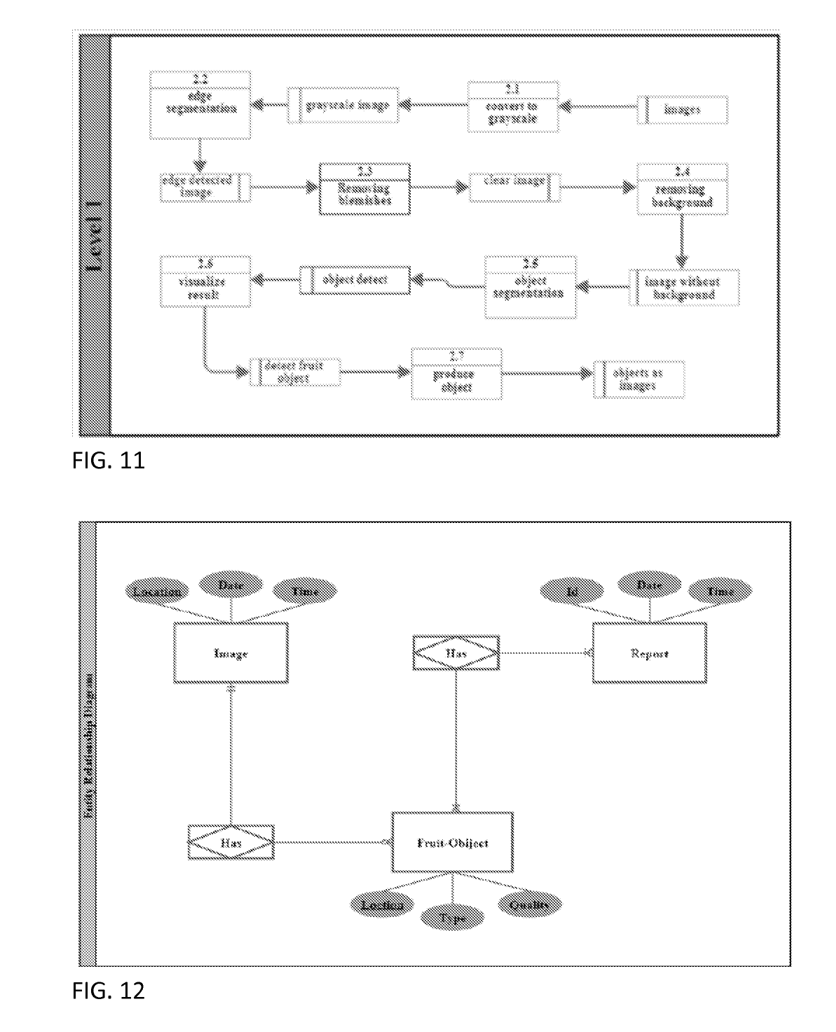

The process is shown in greater detail in FIGS. 11, 13 and 15. As seen in those figures, the captured image is converted to gray scale and the gray scale image is subjected to edge segmentation. Blemishes such as dust on the fruit are then removed to produce a clear image. The background is then removed from the clear image to produce an image without background and that image is subjected to object segmentation. Detected objects are visualized and if a fruit object is detected it is analyzed based on its color and a report is generated and displayed to the user. If a fruit object is not detected the system stops processing. Icons representative of the individual pieces of fruit and their condition are then generated and displayed to the user.

Depending upon the results of the scan, the system will illuminate the fruit icons on the user interface screen with a particular color indicative of the condition of the individual pieces of fruit. The icons will be green for fruit that is not defective, red if the fruit is defective, and orange for fruit that is near defective fruit. The system will generate a report that displays the number of pieces of defective fruit and fruit that is near the defective fruit and potentially affected by it. The user can also request the system to display the location of the defective fruit.

The system of the invention can be retrofitted to an existing refrigerator or can be incorporated in new manufacture. In some cases it can be adapted to refrigerators that already have cameras in them.

While particular embodiments of the invention have been illustrated and described in detail herein, it should be understood that various changes and modifications may be made in the invention without departing from the spirit and intent of the invention as defined by the appended claims.

What is claimed is:

1. A system for monitoring the condition of food items in a refrigerator, comprising:
at least one image taking device positioned in the refrigerator for scanning and capturing images of food items in the refrigerator;
a processor connected with the image taking device to analyze the captured image and assess the condition of the food item based on its color; and
a user interface touchscreen on said refrigerator for displaying the results.

2. A system as claimed in claim 1, wherein:
said at least one image taking device is a camera.

3. A system as claimed in claim 2, wherein:
there are two cameras mounted for movement along vertical rails positioned in said refrigerator at opposite sides thereof so that the cameras can be positioned for taking images of objects on different shelves in the refrigerator.

4. A system as claimed in claim 1, wherein:
said at least one image taking device is a 3D scanner.

5. A system as claimed in claim 4, wherein:
there are two 3D scanners mounted for movement along vertical rails positioned in said refrigerator at opposite sides thereof so that the cameras can be positioned for scanning and taking images of objects on different shelves in the refrigerator.

6. A system as claimed in claim 5, wherein:
said user interface touchscreen displays illuminated icons representative of the condition of food items detected during the scan and shows the location of said items in the refrigerator.

7. A system as claimed in claim 6, wherein:
said system displays a visual alert on said touchscreen when a scan has been completed and a defective food item has been found.

8. A system as claimed in claim 7, wherein:
said touchscreen has a button that can be pushed by the user to cause the system to start a scan.

9. A system as claimed in claim 8, wherein:
said touchscreen has a button that the user can push to cause the system to display a report of the results of a recent scan or the results of scans for a preceding week.

10. A system as claimed in claim 9, wherein:
said touchscreen has a button that the user can push to obtain a display showing the location of said food items in the refrigerator.

11. A system as claimed in claim 10, wherein:
said 3D scanners are connected with a processor that contains software to capture the image taken by the scanners, analyze the image, determine the quality of the food, and produce a report, said software including an operating system, a MATLAB package, a Structured Query Language (SQL) database, and a Database Toolbox that lets the user store data in and access databases from MATLAB with SQL support, enabling the user to analyze, explore, and manipulate the data.

12. A container as claimed in claim 11, wherein:
said food items comprise fruit.

13. A process for monitoring the quality of food items stored in a refrigerator and alerting a user that a food item is spoiled or is on the verge of becoming spoiled, said process comprising the steps of:
providing at least one image taking device in the refrigerator to scan and take images of food items in the refrigerator;
supplying said image to a processor that analyzes the images and assesses their quality based on color; and
displaying on a screen icons representative of the condition of different pieces of said food items.

14. A process as claimed in claim 13, including the steps of:
mounting said at least one image taking device so that it moves vertically in said refrigerator to scan food items on shelves at different levels in the refrigerator.

15. A process as claimed in claim 14, wherein:
said processor uses software including a MATLAB package, a Structured Query Language (SQL) database, and a Database Toolbox that lets the user store data in and access databases from MATLAB with SQL support, enabling the user to analyze, explore, and manipulate the data.

16. A process as claimed in claim 15, wherein:
said at least one image taking device comprises two 3D scanners, wherein the scanners are mounted for vertical movement along respective vertical rails in said refrigerator at opposite sides thereof.
